(19) United States
(12) Patent Application Publication
(10) Pub. No.: US 2026/0048799 A1
(43) Pub. Date: Feb. 19, 2026

(54) PROCESSING DEVICE AND METHOD FOR VEHICLES

(71) Applicant: Atech OEM Inc., New Taipei City (TW)

(72) Inventors: Chien-Hsiung FENG, New Taipei City (TW); I-Tung CHENG, New Taipei City (TW); Zhi-Huang HONG, New Taipei City (TW)

(21) Appl. No.: 18/948,460

(22) Filed: Nov. 14, 2024

(30) Foreign Application Priority Data
Aug. 15, 2024 (TW) 113130657

(51) Int. Cl. B62J 1/08; B62J 45/20; B62J 45/414

(52) U.S. Cl. CPC B62J 1/08; B62J 45/20; B62J 45/414; B62J 2001/085

(57) ABSTRACT

A processing device for vehicles is disclosed, which includes an acceleration sensor and a processor. The processor executes following steps: receiving acceleration information detected by the acceleration sensor in a time sequence; obtaining a maximum acceleration value, a minimum acceleration value, a first time of the maximum acceleration value being detected, and a second time of the minimum acceleration value being detected from the acceleration information; calculating a first acceleration difference between the maximum acceleration value and a gravitational acceleration value and a second acceleration difference between the minimum acceleration value and the gravitational acceleration value; and generating movement information based on the first acceleration difference and the second acceleration difference, where the movement information indicates either a seat of the vehicle is moved upward or the seat of the vehicle is moved downward.

### BACKGROUND OF THE DISCLOSURE

### Technical Field

The disclosure relates to techniques for vehicles, particularly relates to a processing device and method for vehicles.

### Description of Related Art

Since modern human-powered vehicles have to effectively cope with an uphill section, a downhill section and a road condition with different levels of ruggedness, more and more human-powered vehicles have been equipped with an adjustable seat post. When the human-powered vehicle is traveling on the downhill section or in a rugged road condition, a rider usually lowers a height of the adjustable seat post to facilitate adjustment of a center of gravity while riding. On the contrary, when the human-powered vehicle is traveling on a flat road or the uphill section, the rider raises the height of the adjustable seat post in order to allow a body to better deliver power. In addition, when the rider rides the human-powered vehicle and adjusts the height of the adjustable seat post, the rider needs to manually adjust the status of various components of the human-powered vehicle based on the raising or lowering of the adjustable seat post. However, it depends on the humans about whether to raise or lower the adjustable seat post. Therefore, how to automatically determine the raising and lowering of the adjustable seat post is an urgent requirement for technicians in this field.

### SUMMARY OF THE INVENTION

The purpose of the disclosure is to provide a processing device and a method for vehicles, which automatically determine the raising and lowering of an adjustable seat post.

In order to achieve the above purpose, the disclosure provides the processing device for vehicles, suitable for a vehicle having a seat being adjustable, including:
an acceleration sensor, configured for detecting acceleration information of the seat;
a valve controller, configured for controlling a seat post valve to open or close, where the valve controller generates a start signal when the seat post valve is opened, and generates an end signal when the seat post valve is closed, where the seat post valve is disposed in an adjustable seat post on the vehicle, where the adjustable seat post is used for adjusting a height of the seat when the seat post valve is opened, and fixing the height of the seat when the seat post valve is closed; and
a processor, connected to the acceleration sensor and the valve controller, and configured for executing following steps:
receiving the acceleration information detected by the acceleration sensor during a detection time sequence, where the detection time sequence is a time sequence between a time when the start signal is generated and a time when the end signal is generated;
obtaining a maximum acceleration value, a minimum acceleration value, a first time when the acceleration sensor detected the maximum acceleration value, and a second time when the acceleration sensor detected the minimum acceleration value from the acceleration information;
calculating a first acceleration difference between the maximum acceleration value and a gravitational acceleration value and a second acceleration difference between the minimum acceleration value and the gravitational acceleration value;
determining that the first acceleration difference, the second acceleration difference, the first time, and the second time match a first determination condition or a second determination condition, where the first determination condition indicates that an absolute value of the first acceleration difference and an absolute value of the second acceleration difference are greater than an acceleration difference threshold and that the first time precedes the second time, where the second determination condition indicates that the absolute value of the first acceleration difference and the absolute value of the second acceleration difference are greater than the acceleration difference threshold and that the first time is followed by the second time;
when the first acceleration difference, the second acceleration difference, the first time, and the second time match the first determination condition, generating movement information indicating that the seat of the vehicle is moved upward; and
when the first acceleration difference, the second acceleration difference, the first time, and the second time match the second determination condition, generating the movement information indicating that the seat of the vehicle is moved downward.

In order to achieve the above purpose, the disclosure provides the processing method for vehicles, applicable to a vehicle having a seat being adjustable, including:
by a processor, receiving acceleration information of the seat detected by an acceleration sensor during a detection time sequence, where the detection time sequence is a time sequence between a time when a start signal is generated and a time when an end signal is generated, the detection time sequence includes multiple sampling time sequences, the start signal is generated by a valve controller when controlling a seat post valve to open, and the end signal is generated by the valve controller when controlling the seat post valve to close, where the seat post valve is disposed in an adjustable seat post on the vehicle, where the adjustable seat post is used for adjusting a height of the seat when the seat post valve is opened, and fixing the height of the seat when the seat post valve is closed;
by the processor, respectively obtaining multiple acceleration values in each of the multiple sampling time sequences from the acceleration information, and calculating a time length for each of the sampling time sequences;
by the processor, respectively calculating multiple velocities in each of the multiple sampling time sequences based on the multiple acceleration values and the time length;
by the processor, obtaining a maximum velocity and a minimum velocity from the multiple velocities, and determining that the maximum velocity and the minimum velocity match a first determination condition or a second determination condition, where the first determination condition indicates that the maximum velocity is greater than zero and that an absolute value of the maximum velocity is greater than a velocity threshold, and the second determination condition indicates that the minimum velocity is less than zero and that the absolute value of the minimum velocity is greater than the velocity threshold;
when the maximum velocity and the minimum velocity match the first determination condition, by the processor, generating movement information indicating that the seat of the vehicle is moved upward; and
when the maximum velocity and the minimum velocity match the second determination condition, by the processor, generating the movement information indicating that the seat of the vehicle is moved downward.

In order to achieve the above purpose, the disclosure provides the processing method for vehicles, applicable to a vehicle having a seat being adjustable, including:
by a processor, receiving acceleration information of the seat detected by an acceleration sensor during a detection time sequence, where the detection time sequence is a time sequence between a time when a start signal is generated and a time when an end signal is generated, the detection time sequence includes multiple sampling time sequences, the start signal is generated by a valve controller when controlling a seat post valve to open, and the end signal is generated by the valve controller when controlling the seat post valve to close, where the seat post valve is disposed in an adjustable seat post on the vehicle, where the adjustable seat post is used for adjusting a height of the seat when the seat post valve is opened, and fixing the height of the seat when the seat post valve is closed;
by the processor, respectively obtaining multiple acceleration values in each of the multiple sampling time sequences from the acceleration information, and calculating a time length for each of the sampling time sequences;
by the processor, respectively calculating multiple velocities in each of the multiple sampling time sequences based on the multiple acceleration values and the time length;
by the processor, calculating a relative displacement in the detection time sequence based on the velocity in each of the sampling time sequences, and determining that the relative displacement matches a first determination condition or a second determination condition, where the first determination condition indicates that the relative displacement is greater than zero, and the second determination condition indicates that the relative displacement is less than zero;
when the relative displacement matches the first determination condition, by the processor, generating movement information indicating that the seat of the vehicle is moved upward; and
when the relative displacement matches the second determination condition, by the processor, generating the movement information indicating that the seat of the vehicle is moved downward.

Compared to related techniques, the disclosure activates capturing the acceleration information of the seat based on the opening of the seat post valve, and automatically determines a moving direction of the seat based on the relative displacement obtained from the acceleration information. In this way, the disclosure avoids the determination of humans for the moving direction of the seat.

### BRIEF DESCRIPTION OF THE DRAWINGS

FIG. 1 illustrates a block diagram of a processing device for vehicles in some embodiments of the disclosure.

FIG. 2 illustrates a schematic diagram of an adjustable seat post on a vehicle in some embodiments of the disclosure.

FIG. 3 illustrates a flowchart of a processing method for vehicles in some embodiments of the disclosure.

FIG. 4 illustrates a schematic diagram illustrating a waveform of a vertical acceleration value in acceleration information of a seat in some embodiments of the disclosure.

FIG. 5 illustrates a flowchart of further steps included in the processing method for vehicles in other embodiments of the disclosure.

FIG. 6 illustrates a schematic diagram of a waveform of the vertical acceleration value in the acceleration information of the seat in other embodiments of the disclosure.

FIG. 7 illustrates a flowchart of a further step included in the processing method for vehicles in other embodiments of the disclosure.

### DETAILED DESCRIPTION

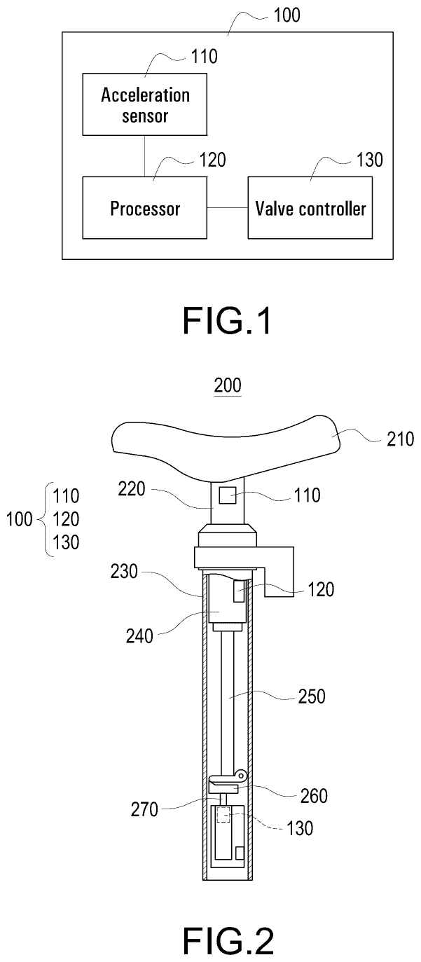

Reference is made to FIG. 1 and FIG. 2, where FIG. 1 illustrates a block diagram of a processing device 100 for vehicles in some embodiments of the disclosure, and FIG. 2 illustrates a schematic diagram of an adjustable seat post 200 on a vehicle in some embodiments of the disclosure. The processing device 100 is suitable for the vehicle having a seat being adjustable (i.e., a seat 210 disposed on the adjustable seat post 200). As shown in FIG. 1 and FIG. 2, the processing device 100 includes an acceleration sensor 110, a processor 120, and a valve controller 130. The processor 120 is connected to the acceleration sensor 110 and the valve controller 130.

In some embodiments, the above vehicle is any vehicle (e.g., a racing bicycle) having the adjustable seat post 200. In some embodiments, the acceleration sensor 110, the processor 120, and the valve controller 130 are disposed on the adjustable seat post 200. In other embodiments, the processor 120 is disposed on another component (e.g., a handlebar grip) on the vehicle.

In some embodiments, the adjustable seat post 200 includes the seat 210, an inner seat post 220, a seat post 230, a valve seat 240, a valve rod 250, a cam block 260, and a drive shaft 270, where the seat 210 is disposed on one end of the inner seat post 220, and the inner seat post 220 is disposed internally within the seat post 230 through another end of the inner seat post 220. A length of a part of the inner seat post 220 exposed outside the seat post 230 is relative to a height of the seat 210. The end of the valve rod 250 engages the cam block 260 to actuate a seat post valve to open or close (i.e., the opening or closing of an oil line or a gas line) within the valve seat 240 by a lever structure, where the seat post valve is an oil type or gas type valve. Further, when a user wants to adjust the height of the seat 210, an external actuator switch (not shown) is activated by the user and triggers the valve controller 130 to control the drive shaft 270 of a motor (not shown) or the lever structure (not shown) driving the cam block 260 to rotate at a preset angle, so that makes the cam block 260 pushing up against the valve rod 250, where the external actuator switch is a push switch, a knob type switch, a touch switch, a lever switch, or another type switch, and there is no particular limitation.

In this way, the upwardly moving valve rod 250 drives the seat post valve inside the valve seat 240 having an open state (i.e., the external actuator switch triggers the valve controller 130 to control the seat post valve to open when activated), and the user further adjusts the height of the seat 210 based on to his/her own needs by adjusting linear displacement of the inner seat post 220 relative to the seat post 230. After the user adjusts the seat 210 to a proper height, as soon as the actuator switch stops being activated by the user, the drive shaft 270 drives the cam block 260 to release thrust on the valve rod 250. At this time, a resilient element located inside the valve seat 240 pushes down on the valve rod 250 and forces the seat post valve inside the seat 240 to close (i.e., the external actuator switch triggers the valve controller 130 to close the seat post valve when no longer activated), thereby completing to position the seat post 220. It should be noted that although this type of adjustable seat post 200 has been used herein as an example, in other embodiments, the adjustable seat post 200 is a commonly used adjustable seat post having a seat post valve and another structure, and is not limited to this embodiment.

In this embodiment, the acceleration sensor 110 is used for detecting acceleration information of the seat 210. In some embodiments, the acceleration sensor 110 is disposed on a position close to the seat 210 (e.g., disposed on the inner seat post 220 (i.e., below the seat 210)). In some embodiments, the acceleration sensor 110 is directly disposed on the seat 210. In some embodiments, the acceleration information includes a single-axis acceleration value (e.g., a vertical acceleration value) or multi-axis acceleration values (e.g., three-axis acceleration values). In some embodiments, the acceleration sensor 110 is implemented by any sensor (e.g., a three-axis gravity sensor (g-sensor) or a Hall effect sensor) that detects the single-axis acceleration value or the multi-axis acceleration values.

In this embodiment, the valve controller 130 is disposed on a position close to the drive shaft 270 for controlling a state (i.e., opened or closed) of the above seat post valve. When controlling the above seat post valve to open, the valve controller 130 generates a start signal based on an open state of the seat post valve; when controlling the above seat post valve to close, the valve controller 130 generates an end signal based on a closed state of the seat post valve. In some embodiments, the valve controller 130 is any type of control circuit (e.g., a combinational logic controller or a microprogrammed controller) for controlling the valve to open or close.

In this embodiment, the processor 120 is used for executing steps in a processing method for vehicles described in subsequent paragraphs. In some embodiments, the processor 120 is implemented by a central processing unit (CPU), a micro control unit (MCU), a programmable logic controller (PLC), a system on chip (SoC), or field programmable gate array (FPGA), but not limited thereto.

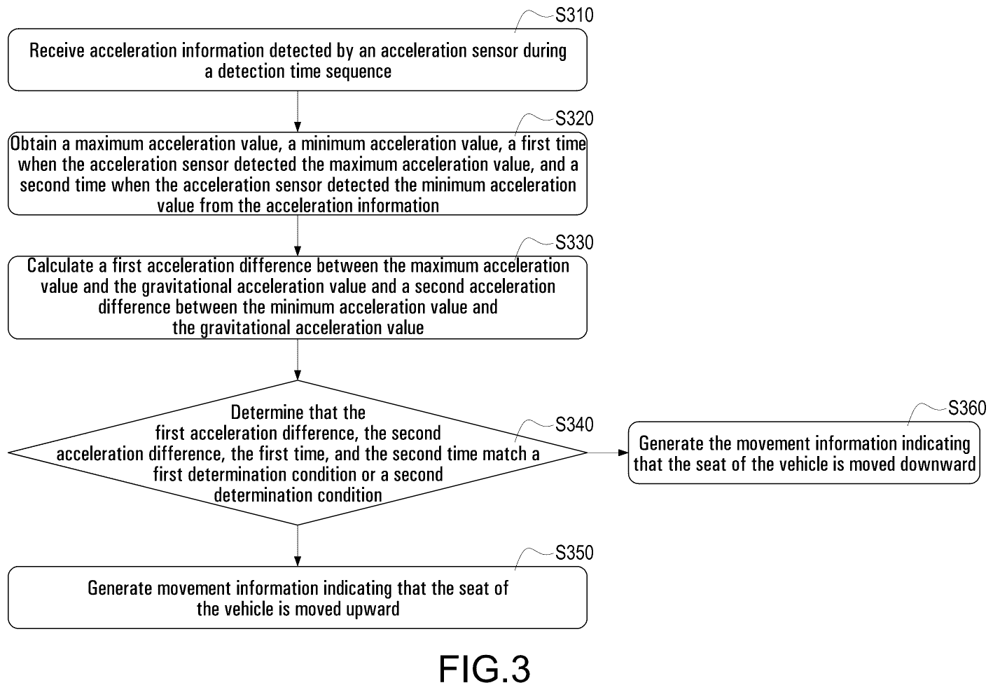

Reference is made to FIG. 3, and FIG. 3 illustrates a flowchart of the processing method for vehicles in some embodiments of the disclosure, which is applicable to the processing device 100 shown in FIG. 1.

As shown in FIG. 3, the processing method for vehicles includes steps S310-S360. First, in step S310, the processor 120 receives the acceleration information detected by the acceleration sensor 110 during a detection time sequence. In this embodiment, the detection time sequence is a time sequence between a time when a start signal is generated and a time when an end signal is generated. In other words, as long as the valve controller 130 controls the seat post valve to open to generate the start signal, the processor 120 starts receiving the acceleration information from the acceleration sensor 110 for subsequent processes when detecting the start signal. On the contrary, as long as the valve controller 130 controls the seat post valve to close to generate the end signal, the processor 120 stops receiving the acceleration information from the acceleration sensor 110 when detecting the end signal.

In step S320, the processor 120 obtains a maximum acceleration value (e.g., 1.5 times a gravitational acceleration value), a minimum acceleration value (e.g., −2 times the gravitational acceleration value), a first time when the acceleration sensor 110 detected the maximum acceleration value, and a second time when the acceleration sensor 110 detected the minimum acceleration value from the acceleration information. In some embodiments, the processor 120 obtains multiple vertical acceleration values (i.e., acceleration values in a direction perpendicular to a roadway surface where the vehicle is traveling) respectively detected at multiple sampling times in the detection time sequence from the acceleration information. Next, the processor 120 respectively selects a maximum and a minimum from the multiple vertical acceleration values as the maximum acceleration value and the minimum acceleration value, and respectively utilizes the sampling time when the maximum acceleration value is detected and the sampling time when the minimum acceleration value is detected as the first time and the second time.

In step S330, the processor 120 calculates a first acceleration difference between the maximum acceleration value and the gravitational acceleration value (i.e., 1 times the gravitational acceleration value) and a second acceleration difference between the minimum acceleration value and the gravitational acceleration value. For example, assuming that the maximum acceleration value and the minimum acceleration value respectively are 2.5 times the gravitational acceleration value and −0.3 times the gravitational acceleration value, the processor 120 respectively calculates the first acceleration difference as 1.5 times the gravitational acceleration value (i.e., 2.5□1=1.5) and the second acceleration difference as −1.3 times the gravitational acceleration value (i.e., □0.3□1=□1.3).

In step S340, the processor 120 determines that the first acceleration difference, the second acceleration difference, the first time, and the second time match a first determination condition or a second determination condition. In this embodiment, the first determination condition indicates that an absolute value of the first acceleration difference and an absolute value of the second acceleration difference are both greater than an acceleration difference threshold (e.g., 1.1 times or 1.2 times the gravitational acceleration value) and that the first time precedes the second time, and the second determination condition indicates that the absolute value of the first acceleration difference and the absolute value of the second acceleration difference are both greater than the acceleration difference threshold and that the first time is after the second time. When the first determination condition is matched, the processor 120 executes step S350. On the contrary, when the second determination condition is matched, the processor 120 executes step S360. In some embodiments, when the processor 120 determines that the first acceleration difference, the second acceleration difference, the first time, and the second time neither match the first determination condition nor the second determination condition, the processor 120 generates movement information indicating that the seat 210 of the vehicle is not moved upward and downward.

In other words, once the processor 120 determines that the absolute value of the first acceleration difference and the absolute value of the second acceleration difference respectively corresponding to the first time and the second time are greater than the acceleration difference threshold, the processor 120 further determines an order of the first time when the maximum acceleration value is detected and the second time when the minimum acceleration value is detected. When the processor 120 determines that the first time precedes the second time (i.e., the first time occurs before the second time), the processor 120 determines that the first acceleration difference, the second acceleration difference, the first time, and the second time match the first determination condition. On the contrary, when the processor 120 determines that the first time is followed by the second time (i.e., the first time occurs after the second time), the processor 120 determines that the first acceleration difference, the second acceleration difference, the first time, and the second time match the second determination condition. In some embodiments, the acceleration difference threshold is pre-set by the user or pre-tested by the user for acceleration values of upward and downward movement of the seat 210 to be set based on these tested acceleration values. For example, when average values of the tested acceleration values for the upward and downward movement respectively are 2.5 times and −1.2 times the gravitational acceleration value, the processor 120 calculates an absolute value of a difference between the average value of the acceleration values for the upward movement and the gravitational acceleration value as 1.5, and calculates an absolute value of a difference between the average value of the acceleration values for the downward movement and the gravitational acceleration value as 0.2. In this way, the user then selects a minimum absolute value, and sets the acceleration difference threshold as a value (e.g., 0.19) being slightly less than the minimum absolute value (i.e., 0.2).

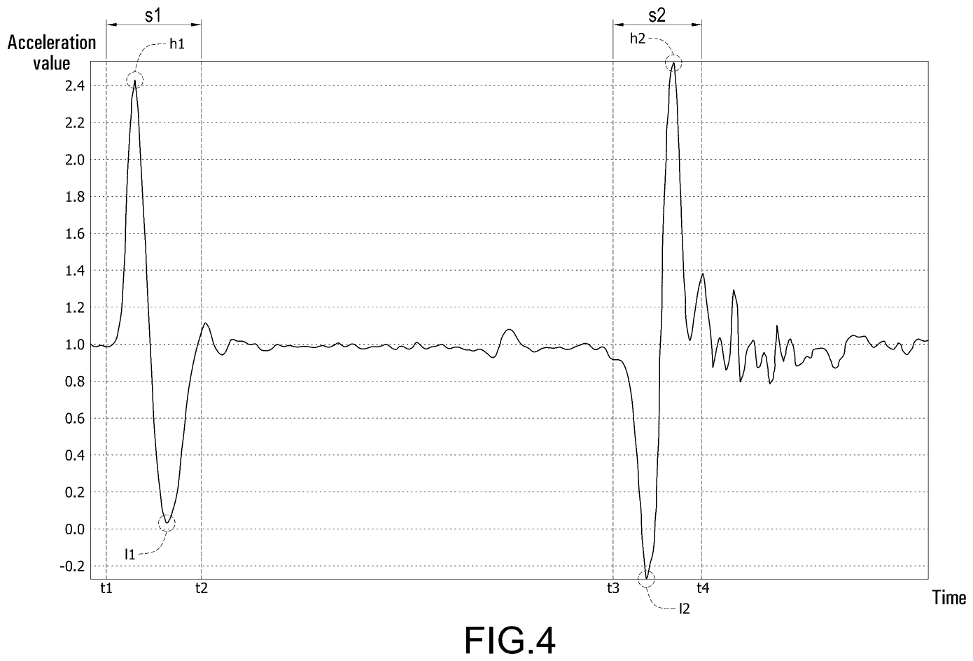

The above determination is explained below in a practical example. Reference is made to FIG. 4, and FIG. 4 illustrates a schematic diagram of a waveform of the vertical acceleration value in the acceleration information of the seat 210 in some embodiments of the disclosure. As shown in FIG. 4, the valve controller 130 respectively controls the seat post valve to open at multiple first times t1 and t3 and to close at multiple second times t2 and t4, so that the processor 120 respectively receives the acceleration information from the acceleration sensor 110 in multiple detection time sequences s1-s2. Next, during the detection time sequence s1, the processor 120 selects a maximum acceleration value h1 (i.e., 2.42 times the gravitational acceleration value) and a minimum acceleration value I1 (i.e., 0.02 times the gravitational acceleration value) from the acceleration information, and calculates the first acceleration difference (i.e., 1.42 times the gravitational acceleration value) between the maximum acceleration value h1 and the gravitational acceleration value and the second acceleration difference (i.e., −0.98 times the gravitational acceleration value) between the minimum acceleration value I1 and the gravitational acceleration value.

Next, the processor 120 determines whether the absolute value of the first acceleration difference corresponding to the maximum acceleration value h1 and the absolute value of the second acceleration difference corresponding to the minimum acceleration value I1 are both greater than the acceleration difference threshold. Assuming the acceleration difference threshold is 0.9 times the gravitational acceleration value, the processor 120 determines that the absolute value of the first acceleration difference and the absolute value of the second acceleration difference are both greater than the acceleration difference threshold. Next, the processor 120 determines that the first time when the maximum acceleration value h1 is detected precedes the second time when the minimum acceleration value I1 is detected. Therefore, the processor 120 determines that the first acceleration difference, the second acceleration difference, the first time, and the second time during the detection time sequence s1 have matched the first determination condition.

During the detection time sequence s2, the processor 120 selects the maximum acceleration value h2 (i.e., 2.5 times the gravitational acceleration value) and the minimum acceleration value I2 (i.e., −0.25 times the gravitational acceleration value) from the acceleration information, and calculates the first acceleration difference (i.e., 1.5 times the gravitational acceleration value) between the maximum acceleration value h2 and the gravitational acceleration value and the second acceleration difference (i.e., −1.25 times the gravitational acceleration value) between the minimum acceleration value I2 and the gravitational acceleration value.

Next, the processor 120 determines whether the absolute value of the first acceleration difference corresponding to the maximum acceleration value h2 and the absolute value of the second acceleration difference corresponding to the minimum acceleration value I2 are both greater than the acceleration difference threshold. Since the acceleration difference threshold is 0.9 times the gravitational acceleration value, the processor 120 determines that the absolute value of the maximum acceleration value h2 and the minimum acceleration value I2 are both greater than the acceleration difference threshold. Next, the processor 120 determines that the first time when the maximum acceleration value h2 is detected is followed by the second time when the minimum acceleration value I2 is detected. Therefore, the processor 120 determines that the first acceleration difference, the second acceleration difference, the first time, and the second time during the detection time sequence s2 have matched the second determination condition.

Back to FIG. 3, in step S350, the processor 120 generates the movement information indicating that the seat 210 of the vehicle is moved upward. In step S360, the processor 120 generates the movement information indicating that the seat 210 of the vehicle is moved downward. In other words, once the processor 120 determines that the first acceleration difference, the second acceleration difference, the first time, and the second time have matched the first determination condition, the processor 120 determines that the seat 210 of the vehicle has been moved upward. On the contrary, once the processor 120 determines that the first acceleration difference, the second acceleration difference, the first time, and the second time have matched the second determination condition, the processor 120 determines that the seat 210 of the vehicle has been moved downward.

For example, as shown in FIG. 4, during the detection time sequence s1, the processor 120 determines that the first acceleration difference, the second acceleration difference, the first time, and the second time have matched the first determination condition, and then generates the movement information indicating that the seat 210 of the vehicle is moved upward. During the detection time sequence s2, the processor 120 determines that the first acceleration difference, the second acceleration difference, the first time, and the second time have matched the second determination condition, and then generates the movement information indicating that the seat 210 of the vehicle is moved downward.

In some embodiments, the processor 120 adjusts adjustable components on the vehicle (e.g., adjusting shock absorbers or a gear system) based on the movement information. For example, when the movement information indicates that the seat 210 of the vehicle has been moved upward, the processor 120 increases damping strength of the shock absorbers or upshifts the gear system. When the movement information indicates that the seat 210 of the vehicle has been moved downward, the processor 120 decreases the damping strength of the shock absorbers or downshift in the gear system.

By the above steps, the disclosure activates capturing the acceleration information of the seat 210 based on the opening of the seat post valve, and automatically determines whether the seat 210 is moved upward or downward based on the maximum acceleration value, the minimum acceleration value, the first time when the maximum acceleration value is detected, and the second time when the minimum acceleration value is detected in the acceleration information. In this way, the disclosure adjusts states of various components of the vehicle based on a moving direction of the seat 210 identified automatically, so that avoids the determination of humans for the moving direction of the seat 210 and the determination of humans for the states of various components of the vehicle. In addition, since the above steps only capture the maximum acceleration value, the minimum acceleration value, the first time when the maximum acceleration value is detected, and the second time when the minimum acceleration value is detected, the disclosure adopts the above steps to greatly reduce required computing resources (i.e., by utilizing processor 120 with lower computing power and lower power consumption (e.g., an edge computing processor)).

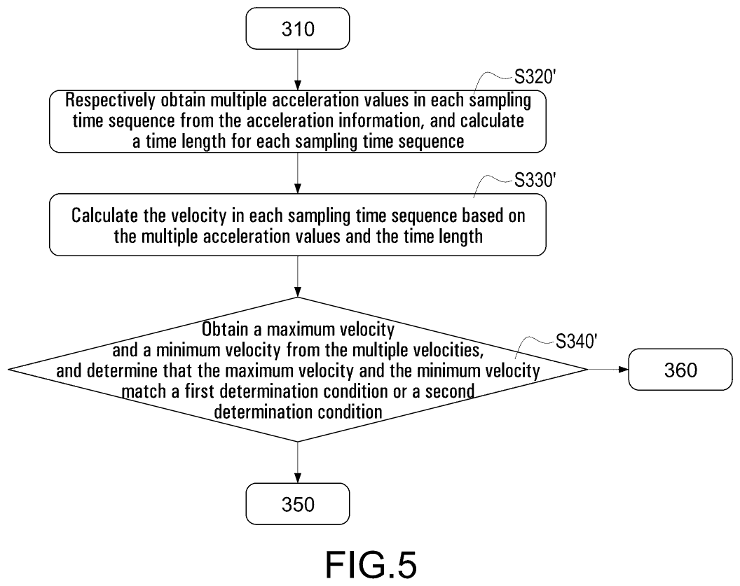

Reference is made to FIG. 5, and FIG. 5 illustrates a flowchart of steps S320′-S340′ executed after step S310 in the processing method for vehicles of FIG. 3 in some embodiments of the disclosure. As shown in FIG. 5, in this embodiment, after the processor 120 executes step S310 of FIG. 3, the processor 120 executes steps S320′-S340′. In step S320′, the processor 120 respectively obtains multiple acceleration values in each sampling time sequence from the acceleration information, and calculates a time length (e.g., 2 milliseconds for all) for each sampling time sequence. In this embodiment, the multiple sampling time sequences are included in the detection time sequence. In some embodiments, the processor 120 obtains an average vertical acceleration value (e.g., integrating the vertical acceleration values and dividing by the time length) in each sampling time sequence from the acceleration information as the acceleration value in each sampling time sequence. In other embodiments, the processor 120 obtains the vertical acceleration value at one sampling time in each sampling time sequence from the acceleration information as the acceleration value in each sampling time sequence.

In step S330′, the processor 120 calculates the velocity in each sampling time sequence based on the multiple acceleration values and the time length. In some embodiments, the processor 120 subtracts the gravitational acceleration value from each acceleration value to generate an acceleration difference in each sampling time sequence. Next, the processor 120 multiplies the acceleration differences in each sampling time sequence and the sampling time sequences preceding each sampling time sequence by the time length to generate multiple product values, and utilizing a sum of the multiple product values as the velocity (i.e., an approximate velocity) in each sampling time sequence.

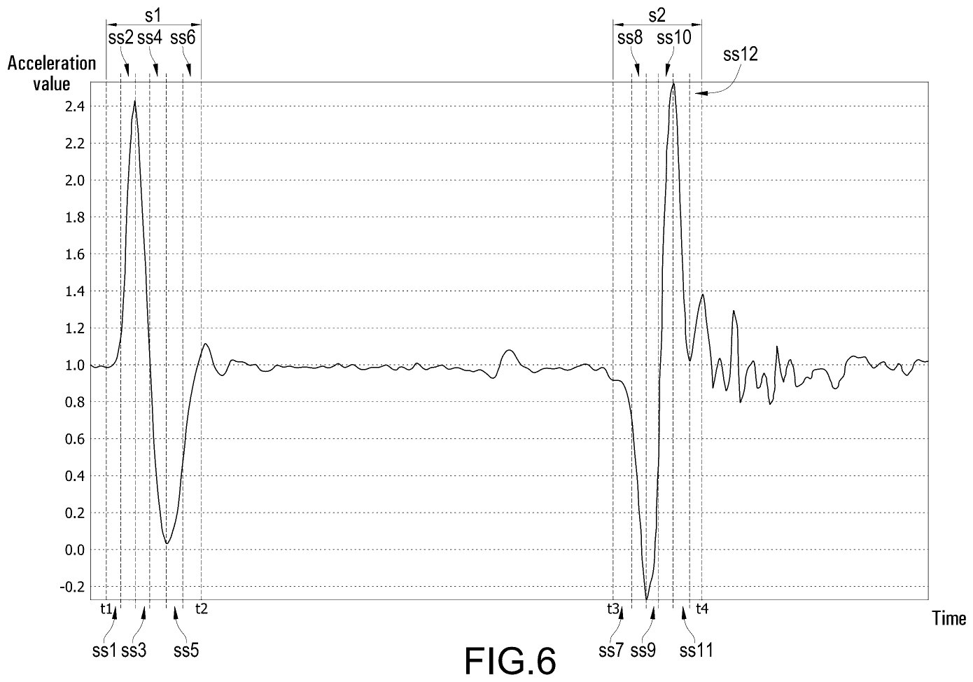

How to calculate the velocities in each sampling time sequence is explained below by a practical example. Reference is made to FIG. 6, and FIG. 6 illustrates a schematic diagram of a waveform of the vertical acceleration value in the acceleration information of the seat 210 in some embodiments of the disclosure. As shown in FIG. 6, the valve controller 130 controls the seat post valve to respectively open at the multiple first times t1 and t3 and to respectively close at the multiple second times t2 and t4, so that the processor 120 respectively receives the acceleration information in the multiple detection time sequences s1-s2 from the acceleration sensor 110. During the detection time sequence s1, the processor 120 obtains the multiple acceleration values in the multiple sampling time sequences ss1-ss6 from the acceleration information, and calculates the time length for each sampling time sequence. The sampling time sequences ss1-ss6 in this example all have the same time length. Next, the processor 120 executes a subtraction operation on each acceleration value and the gravitational acceleration value (i.e., respectively subtracting the gravitational acceleration value from the acceleration value in each of the sampling time sequences ss1-ss6) to generate the acceleration difference in each of the sampling time sequences ss1-ss6.

Next, the processor 120 multiplies the acceleration difference in the sampling time sequence ss1 and the time length of the sampling time sequence ss1 to generate a first product value, and utilizes the first product value as the velocity in the sampling time sequence ss1. The processor 120 multiplies the acceleration difference in the sampling time sequence ss2 and the time length of the sampling time sequence ss2 to generate a second product value, and utilizes a sum of the first product value and the second product value as the velocity in the sampling time sequence ss2. The processor 120 multiplies the acceleration difference in the sampling time sequence ss3 and the time length of the sampling time sequence ss3 to generate a third product value, and utilizes a sum of the first product value, the second product value, and the third product value as the velocity in the sampling time sequence ss3. By analogy, the processor 120 calculates the velocities in the sampling time sequence ss4-ss6 in the same manner.

During the detection time sequence s2, the processor 120 obtains the multiple acceleration values in the multiple sampling time sequences ss7-ss12 from the acceleration information, and calculates the time length for each sampling time sequence. The sampling time sequences ss7-ss12 in this example all have the same time length. Next, the processor 120 executes the subtraction operation on each acceleration value and the gravitational acceleration value (i.e., respectively subtracting the gravitational acceleration value from the acceleration value in each of the sampling time sequences ss7-ss12) to generate the multiple acceleration differences in each of the sampling time sequences ss7-ss12.

Next, the processor 120 multiplies the acceleration difference in the sampling time sequence ss7 and the time length of the sampling time sequence ss7 to generate a seventh product value, and utilizes the seventh product value as the velocity in the sampling time sequence ss7. The processor 120 multiplies the acceleration difference in the sampling time sequence ss8 and the time length of the sampling time sequence ss8 to generate an eighth product value, and utilizes a sum of the seventh product value and the eighth product value as the velocity in the sampling time sequence ss8. The processor 120 multiplies the acceleration difference in the sampling time sequence ss9 and the time length of the sampling time sequence ss9 to generate a ninth product value, and utilizes a sum of the seventh product value, the eighth product value, and the ninth product value as the velocity in the sampling time sequence ss9. By analogy, the processor 120 calculates the velocities in the sampling time sequences ss10-ss12 in the same manner.

Back to FIG. 5, in step S340′, the processor 120 obtains a maximum velocity and a minimum velocity from the multiple velocities, and determines that the maximum velocity and the minimum velocity match a first determination condition or a second determination condition. In this embodiment, the first determination condition indicates that the maximum velocity is greater than zero and that an absolute value of the maximum velocity is greater than a velocity threshold (e.g., 2 meters/second), and the second determination condition indicates that the minimum velocity is less than zero and that an absolute value of the minimum velocity is greater than the velocity threshold. When the first determination condition is matched, the processor 120 executes step S350 of FIG. 3. On the contrary, when the second determination condition is matched, the processor 120 executes step S360 of FIG. 3.

In other words, the processor 120 selects a maximum and a minimum from the multiple velocities, and determines whether the maximum velocity is greater than zero and its absolute value is greater than the velocity threshold. Once the maximum velocity is greater than zero and the absolute value of the maximum velocity is greater than the velocity threshold, the processor 120 determines that the maximum velocity and the minimum velocity have matched the first determination condition. On the contrary, when the maximum velocity is not greater than zero or the absolute value of the maximum velocity is not greater than the velocity threshold, the processor 120 further determines whether the minimum velocity is less than zero and its absolute value is greater than the velocity threshold. Once the minimum velocity is less than zero and the absolute value of the minimum velocity is greater than the velocity threshold, the processor 120 determines that the maximum velocity and the minimum velocity has matched the second determination condition.

For example, as shown in FIG. 6, during the detection time sequence s1, the processor 120 determine that the velocity in the sampling time sequence ss3 is the maximum velocity (because of having a maximum sum of the product values) and the velocity in the sampling time sequence ss6 is the minimum velocity (because of having a minimum sum of the product values). Assuming that the processor 120 determines that the velocity in the sampling time sequence ss3 is greater than zero and that the absolute value of the velocity in the sampling time sequence ss3 is greater than a velocity threshold, the processor 120 determines that the maximum velocity and the minimum velocity have matched the first determination condition.

During the detection time sequence s2, the processor 120 determines that the velocity in the sampling time sequence ss12 is the maximum velocity (because of having the maximum sum of the product values) and the velocity in the sampling time sequence ss9 is the minimum velocity (because of having the minimum sum of the product values). Assuming that the processor 120 determines that the velocity in the sampling time sequence ss9 is less than zero and that the absolute value of the velocity in the sampling time sequence ss9 is greater than the velocity threshold, the processor 120 determines that the maximum velocity and the minimum velocity have matched the second determination condition.

In other embodiments, the second determination condition indicates that the minimum velocity is less than zero and that the absolute value of the minimum velocity is greater than another velocity threshold (e.g., 1.5 meters/second (because the absolute value of the maximum downward velocity sometimes is less than the absolute value of the maximum upward velocity)). In some embodiments, the velocity threshold is pre-set by the user or pre-tested by the user for maximum velocities of upward and downward movement of the seat 210 to be set based on these tested velocities (e.g., when the maximum velocities of upward and downward movement being tested respectively are 2 meters/second and −1.5 meters/second, the user set the velocity threshold as 1.4 meters/second). In some embodiments, when the processor 120 determines that the maximum velocity and the minimum velocity do not match the first determination condition and the second determination condition, the processor 120 generates the movement information indicating that the seat 210 of the vehicle is not moved upward and downward.

By the above steps, the disclosure also activates capturing the acceleration information of the seat 210 based on the opening of the seat tube valve, and automatically determines whether the seat 210 is moved upward or downward based on the maximum velocity and the minimum velocity in the acceleration information. In this way, the disclosure also adjusts the states of various components of the vehicle based on the moving direction of the seat 210 identified automatically, so that avoids the determination of humans for the moving direction of the seat 210 and the determination of humans for the states of various components of the vehicle. In addition, since the above steps only require calculating the maximum velocity and the minimum velocity by utilizing the multiple acceleration values captured during the multiple sampling time sequences, the disclosure adopts the above steps to avoid requiring high computational resources (i.e., a simple architecture of the processor 120).

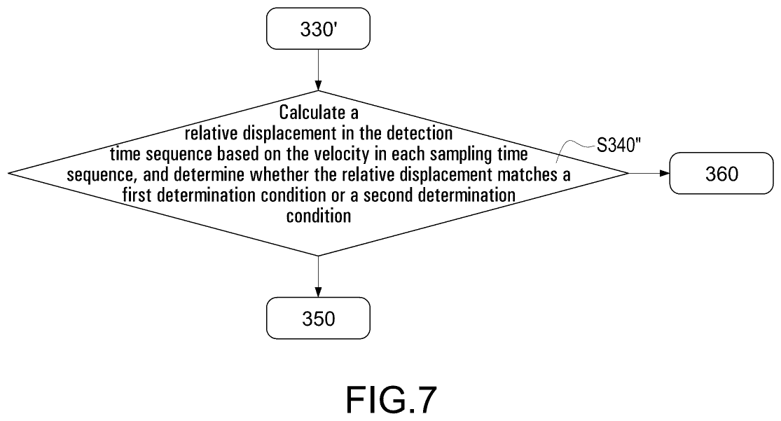

Reference is made to FIG. 7, and FIG. 7 illustrates a flowchart of step S340″ executed after step S330′ in the processing method for vehicles of FIG. 5 in some embodiments of the disclosure. As shown in FIG. 5, in this embodiment, after executing step S330′ of FIG. 5, the processor 120 executes step S340″. In step S340″, the processor 120 calculates a relative displacement (i.e., a vertical displacement relative to the position of the seat 210 before the seat post valve opens) in the detection time sequence based on the velocity in each sampling time sequence, and determines whether the relative displacement matches a first determination condition or a second determination condition. When the first determination condition is matched, the processor 120 executes step S350 of FIG. 3. On the contrary, when the second determination condition is matched, the processor 120 executes step S360 of FIG. 3. In some embodiments, the processor 120 multiplies the velocity in each sampling time sequence and the time length to generate multiple product values (i.e., instantaneous approximate displacements), and utilizes a sum of the multiple product values as the relative displacement (i.e., an approximate total displacement) in the detection time sequence. In this embodiment, the first determination condition indicates that the relative displacement is greater than zero, and the second determination condition indicates that the relative displacement is less than zero.

For example, as shown in FIG. 6, during the detection time sequence s1, the processor 120 respectively multiplies the velocities in the sampling time sequences ss1-ss6 and the time length of the sampling time sequences ss1-ss6 to generate the multiple product values, and utilizes the sum of the multiple product values as the relative displacement in the detection time sequences1. Assuming that the processor 120 determines that the relative displacement in the detection time sequence s1 is greater than zero (i.e., a positive displacement amount), the processor 120 determines that the relative displacement has matched the first determination condition.

During the detection time sequence s2, the processor 120 respectively multiplies the velocities in the sampling time sequences ss7-ss12 and the time length of the sampling time sequences ss7-ss12 to generate the multiple of product values, and utilizes the sum of the multiple product values as the relative displacement in the detection time sequence s2. Assuming that the processor 120 determines that the relative displacement in the detection time sequence s2 is less than zero (i.e., a negative displacement amount), the processor 120 determines that the relative displacement has matched the second determination condition.

By the above steps, the disclosure also activates capturing the acceleration information of the seat 210 based on the opening of the seat post valve, and automatically determines whether the seat 210 is moved upward or downward based on the relative displacement from the acceleration information. In this way, the disclosure also adjusts the states of various components of the vehicle based on the moving direction of the seat 210 identified automatically, so that avoids the determination of humans for the moving direction of the seat 210 and the determination of humans for the states of various components of the vehicle. In addition, the disclosure adopts the above steps to further improve the accuracy of determining whether the seat 210 is moved upward or downward.

In summary, the processing device and method for vehicles proposed in the disclosure activate capturing the acceleration information of the seat by utilizing the opening of the seat post valve, and stop capturing the acceleration information of the seat by utilizing the closing of the seat post valve. Next, the processing device and method for vehicles proposed in the disclosure obtain the acceleration value, the velocity, or the displacement of the seat from the acceleration information, and automatically determine whether the seat is moved upward or downward based on the acceleration value, the velocity, or the displacement of the seat. In this way, the processing device and method for vehicles proposed in the disclosure avoid identifying the moving direction of the seat by utilizing the determination of humans, so that adjusts the states of various components of the vehicle by utilizing the moving direction of the seat. This completely eliminates the need for the determination of human and human operations in the past. In addition, the processing device and the method for vehicles proposed in the disclosure not only greatly reduce the consumption of computing resources but also greatly improve the accuracy of identifying the moving direction of the seat.

While this disclosure has been described by means of specific embodiments, numerous modifications and variations may be made thereto by those skilled in the art without departing from the scope and spirit of this disclosure set forth in the claims.

What is claimed is:

1. A processing device for vehicles, suitable for a vehicle having a seat being adjustable, comprising:
an acceleration sensor, configured for detecting acceleration information of the seat;
a valve controller, configured for controlling a seat post valve to open or close, wherein the valve controller generates a start signal when the seat post valve is opened, and generates an end signal when the seat post valve is closed, wherein the seat post valve is disposed in an adjustable seat post on the vehicle, wherein the adjustable seat post is used for adjusting a height of the seat when the seat post valve is opened and fixing the height of the seat when the seat post valve is closed; and
a processor, connected to the acceleration sensor and the valve controller, and configured for executing following steps:
receiving the acceleration information detected by the acceleration sensor during a detection time sequence, wherein the detection time sequence is a time sequence between a time when the start signal is generated and a time when the end signal is generated;
obtaining a maximum acceleration value, a minimum acceleration value, a first time when the acceleration sensor detected the maximum acceleration value, and a second time when the acceleration sensor detected the minimum acceleration value from the acceleration information;
calculating a first acceleration difference between the maximum acceleration value and a gravitational acceleration value and a second acceleration difference between the minimum acceleration value and the gravitational acceleration value;
determining that the first acceleration difference, the second acceleration difference, the first time, and the second time match a first determination condition or a second determination condition, wherein the first determination condition indicates that an absolute value of the first acceleration difference and an absolute value of the second acceleration difference are greater than an acceleration difference threshold and that the first time precedes the second time, wherein the second determination condition indicates that the absolute value of the first acceleration difference and the absolute value of the second acceleration difference are greater than the acceleration difference threshold and that the first time is followed by the second time;
when the first acceleration difference, the second acceleration difference, the first time, and the second time match the first determination condition, generating movement information indicating that the seat of the vehicle is moved upward; and
when the first acceleration difference, the second acceleration difference, the first time, and the second time match the second determination condition, generating the movement information indicating that the seat of the vehicle is moved downward.

2. The processing device for vehicles of claim 1, wherein in the step of obtaining the maximum acceleration value, the minimum acceleration value, the first time when the acceleration sensor detected the maximum acceleration value, and the second time when the acceleration sensor detected the minimum acceleration value from the acceleration information, the processor is configured for executing following steps:
obtaining a plurality of vertical acceleration values respectively detected at each of a plurality of sampling times in the detection time sequence from the acceleration information; and
respectively selecting a maximum and a minimum from the plurality of vertical acceleration values as the maximum acceleration value and the minimum acceleration value, and respectively utilizing the sampling time when the maximum acceleration value is detected and the sampling time when the minimum acceleration value is detected as the first time and the second time.

3. The processing device for vehicles of claim 1, wherein the processor is configured for further executing following steps:
when determining that the first acceleration difference, the second acceleration difference, the first time, and the second time neither match the first determination condition nor the second determination condition, generating the movement information indicating that the seat of the vehicle is not moved upward and downward.

4. The processing device for vehicles of claim 1, wherein the processor is configured for further executing following steps:
adjusting at least one adjustable component on the vehicle based on the movement information.

5. A processing method for vehicles, applicable to a vehicle having a seat being adjustable, comprising:
by a processor, receiving acceleration information of the seat detected by an acceleration sensor during a detection time sequence, wherein the detection time sequence is a time sequence between a time when a start signal is generated and a time when an end signal is generated, the detection time sequence comprises a plurality of sampling time sequences, the start signal is generated by a valve controller when controlling a seat post valve to open, and the end signal is generated by the valve controller when controlling the seat post valve to close, wherein the seat post valve is disposed in an adjustable seat post on the vehicle, wherein the adjustable seat post is used for adjusting a height of the seat when the seat post valve is opened and fixing the height of the seat when the seat post valve is closed;
by the processor, respectively obtaining a plurality of acceleration values in each of the plurality of sampling time sequences from the acceleration information, and calculating a time length for each of the sampling time sequences;
by the processor, respectively calculating a plurality of velocities in each of the plurality of sampling time sequences based on the plurality of acceleration values and the time length;
by the processor, obtaining a maximum velocity and a minimum velocity from the plurality of velocities, and determining that the maximum velocity and the minimum velocity match a first determination condition or a second determination condition, wherein the first determination condition indicates that the maximum velocity is greater than zero and that an absolute value of the maximum velocity is greater than a velocity threshold, and the second determination condition indicates that the minimum velocity is less than zero and that the absolute value of the minimum velocity is greater than the velocity threshold;
when the maximum velocity and the minimum velocity match the first determination condition, by the processor, generating movement information indicating that the seat of the vehicle is moved upward; and
when the maximum velocity and the minimum velocity match the second determination condition, by the processor, generating the movement information indicating that the seat of the vehicle is moved downward.

6. The processing method for vehicles of claim 5, wherein the step of respectively calculating the plurality of velocities in each of the plurality of sampling time sequences based on the plurality of acceleration values and the time length comprises:
by the processor, respectively subtracting each of the acceleration values from a gravitational acceleration value to generate an acceleration difference in each of the sampling time sequences; and
by the processor, multiplying all of the acceleration differences in each of the sampling time sequences and in all of the sampling time sequences preceding each of the sampling time sequences by the time length to generate a plurality of product values, and utilizing a sum of the plurality of product values as the velocity in each of the sampling time sequences.

7. The processing method for vehicles of claim 5, further comprising:
when determining that the maximum velocity and the minimum velocity neither match the first determination condition nor the second determination condition, by the processor, generating the movement information indicating that the seat of the vehicle is not moved upward and downward.

8. The processing method for vehicles of claim 5, further comprising:
by the processor, adjusting at least one adjustable component of the vehicle based on the movement information.

9. A processing method for vehicles, applicable to a vehicle having a seat being adjustable, comprising:
by a processor, receiving acceleration information of the seat detected by an acceleration sensor during a detection time sequence, wherein the detection time sequence is a time sequence between a time when a start signal is generated and a time when an end signal is generated, the detection time sequence comprises a plurality of sampling time sequences, the start signal is generated by a valve controller when controlling a seat post valve to open, and the end signal is generated by the valve controller when controlling the seat post valve to close, wherein the seat post valve is disposed in an adjustable seat post on the vehicle, wherein the adjustable seat post is used for adjusting a height of the seat when the seat post valve is opened and fixing the height of the seat when the seat post valve is closed;
by the processor, respectively obtaining a plurality of acceleration values in each of the plurality of sampling time sequences from the acceleration information, and calculating a time length for each of the sampling time sequences;
by the processor, respectively calculating a plurality of velocities in each of the plurality of sampling time sequences based on the plurality of acceleration values and the time length;
by the processor, calculating a relative displacement in the detection time sequence based on the velocity in each of the sampling time sequences, and determining that the relative displacement matches a first determination condition or a second determination condition, wherein the first determination condition indicates that the relative displacement is greater than zero, and the second determination condition indicates that the relative displacement is less than zero;
when the relative displacement matches the first determination condition, by the processor, generating movement information indicating that the seat of the vehicle is moved upward; and
when the relative displacement matches the second determination condition, by the processor, generating the movement information indicating that the seat of the vehicle is moved downward.

10. The processing method for vehicles of claim 9, wherein the step of calculating the relative displacement in the detection time sequence based on the velocity in each of the sampling time sequences comprises:
multiplying the velocity and the time length for each of the sampling time sequences to generate a plurality of product values, and utilizing a sum of the plurality of product values as the relative displacement in the detection time sequence.
